(19) United States
(12) Patent Application Publication
(10) Pub. No.: US 2009/0024611 A1
(43) Pub. Date: Jan. 22, 2009

(54) System and method for transmitting securities information

(76) Inventors: Ching Feng Wang, Tainan City (TW); Chuan Da Hsiung, Taipei City (TW)

Correspondence Address: Raymond Sun, 12420 Woodhall Way, Tustin, CA, 92782, US

(21) Appl. No.: 12/002,661

(22) Filed: Dec. 18, 2007

(30) Foreign Application Priority Data
Jul. 20, 2007 (TW) 096126490

(51) Int. Cl. G06F 7/10; G06F 17/30

(52) U.S. Cl. 707/5; 707/E17.001; 707/E17.017

(57) ABSTRACT

A system for transmitting information about securities comprising: a relational database and an analysis processor. The relational database is used to store a relational table that contains a plurality of relations concerning users of securities. When the analysis processor receives information about securities, the analysis processor determines a plurality of users who match the information about securities according to the relational table, and then transmits the information about securities to the plurality of users. When the system is transmitting information about securities, relational tables are established in order to reduce search loops that are required for determining the users, thus speeding up operations of the system and reducing system loads.

### BACKGROUND OF INVENTION

1. Field of the Invention

The invention relates to a system for transmitting information about securities and method thereof, and particularly to such a system wherein when information about securities is transmitted to users, a relational table recording relationships between the users and the information about securities is established, so as to reduce the necessary search loops.

2. Description of the Prior Art

As the information technology rapidly advances, the demand for more convenient and instantaneous acquirement of communication and information also grows exponentially. As a result, a variety of portable wireless communication devices have been constantly developed in order to satisfy such demand. For instance, the development of various cell phones, smart phones, handheld stock managers, and personal digital assistant (PDA) with mobile communication.

In addition to the aforesaid wireless communication devices, software that may be used in combination with the mentioned hardware has also been developed and introduced continually, so as to allow users to carry out tasks like managing personal finances, working, entertaining themselves, or obtaining information more conveniently and instantaneously. For example, the use of a wireless communication device for carrying out electronic transactions of securities like stocks or futures. Apart from being used to carry out electronic transactions, the wireless communication devices used to carry out electronic transactions of stocks or futures have another important function, which is to be used to receive broadcasts of information about the securities, so that users may acquire information about securities as soon as possible, and at anytime and anywhere.

FIG. 1 is a flow chart that shows a service for transmitting information about securities according to prior arts; comprising:

Step 20: starting a service for transmitting information about securities.

Step 21: receiving information about stock transactions, and extracting stock codes from the information about stock transactions, so that the stock codes may be used as a reference for determining which users match the information about the stock transactions.

Step 22: determining which users match the information about the stock transactions; and the step 22 further comprises steps 221 and 222.

Step 221: examining stocks one by one in a user's portfolio, so as to determine whether there is any stock codes that match the information about the stock transactions in the portfolio.

Step 222: examining each of the users one by one by using the same method as in the step 221, so as to determine users who match the information about the stock transactions.

Step 23: transmitting the information about the stock transactions to users.

Step 24: ending the service for transmitting information about securities.

In a TCP/IP network, if particular information is to be transmitted to specific users, the only way is to transmit the information to the specific users one by one. Using the currently known service for transmitting information about securities, if information about transactions concerning the stocks in users' portfolios is to be transmitted to users, the information is transmitted via the following method:

Assuming there are currently four users A, B, C, and D; each of which is represented as 1, 2, 3, and 1000 in user codes, and the numbers 2002, 2303, and 2330 are codes that represent three different types of securities from the user-selected portfolios of the four users. Moreover, the user-selected portfolios of the four users are listed below:

A: 2330, 2303, and 2002

B: 2330

C: 2303 and 2002

D: 2002 and 2330

The current method employs two loops for the transmission of the information. When the information about stock transactions is received, the portfolios of users are checked one by one to see if particular stocks are present; if the particular stocks are indeed present, the information about stock transactions is added into a buffer zone for the user. Referring to FIG. 2, which is a schematic view that shows processing of loops in a conventional service for transmitting information about securities. Assuming that a server in the service for transmitting information about securities may serve up to 1000 users, and each user may select 100 stocks in his/her own user-selected portfolio; if the conventional service shown in FIG. 2 is used to process search loops, an average number of loops required for transmitting information about securities of any one of the stocks to its users would be 1000×50.5=50500 (assuming that each user selects an average number of 100 stocks in his/her own user-selected portfolio, an average number of loops for a stock is: (1+2+3 . . . +100)/100=50.5, which is the average number for the step 221). As a result, when the number of users each server serves is increased, the number of loops will also rise sharply, which adds pressure to system loads.

### SUMMARY OF INVENTION

The primary objective of the invention is to propose a system for transmitting information about securities and method thereof, which may reduce the search loops required for determining users to receive the information about securities by establishing a relational table, as well as speeding up operations of the system and reducing system loads.

In order to achieve the aforementioned objective, the present invention discloses a system for transmitting information about securities, which comprises a relational database and an analysis processor. The relational database is used to store a relational table that contains a plurality of relations concerning users of securities. When the analysis processor receives information about securities, the analysis processor determines a plurality of users who match the information about securities according to the relational table, and then transmits the information about securities to the plurality of users. When the system is transmitting information about securities, relational tables are established in order to reduce search loops that are required for determining the users, thus speeding up operations of the system and reducing system loads.

In order to achieve the aforementioned objective, the present invention further discloses a method for transmitting information about securities, which comprises the steps of:

(1) statistically summarizing a plurality of user information for obtaining a plurality of relations concerning users of securities;

(2) storing the plurality of relations concerning users of securities into a relational table; and

(3) when receiving information about securities, determining a plurality of users who match the information about securities according to the relational table, and then transmitting the information about securities to the determined plurality of users.

In a preferred embodiment of the invention, the relational table comprises at least one of following relations: a relation between names of securities and a plurality of users, and a relation between codes of securities and a plurality of users.

In a preferred embodiment of the invention, the information about securities comprises at least one of following details: names of securities, codes of securities, and messages of securities.

In a preferred embodiment of the invention, the plurality of relations concerning users of securities is obtained by allowing the analysis processor to statistically summarize a plurality of user information from all users uploaded into the system.

In a preferred embodiment of the invention, the user information comprises at least one of following details: user-selected securities, records of inquiries, records of completed transactions, and personal information.

In a preferred embodiment of the invention, the relations between a plurality of securities and a plurality of users in the relational table are an associative array.

### BRIEF DESCRIPTION OF THE DRAWINGS

The structure and the technical means adopted by the present invention to achieve the above and other objectives can be best understood by referring to the following detailed description of the preferred embodiments and the accompanying diagrams, wherein:

FIG. 1 is a flow chart that shows a service for transmitting information about securities according to prior arts;

FIG. 2 is a schematic view that shows processing of loops in a conventional service for transmitting information about securities;

FIG. 3 is a schematic view that shows a system for transmitting information about securities according to a preferred embodiment of the invention;

FIG. 4 is a schematic view that shows processing of loops in the system for transmitting information about securities according to the invention;

FIG. 5 is a schematic view that shows relational tables in the system for transmitting information about securities of the invention are arranged in associative arrays;

FIG. 6 is a flow chart that shows a method for transmitting information about securities according to a preferred embodiment of the invention.

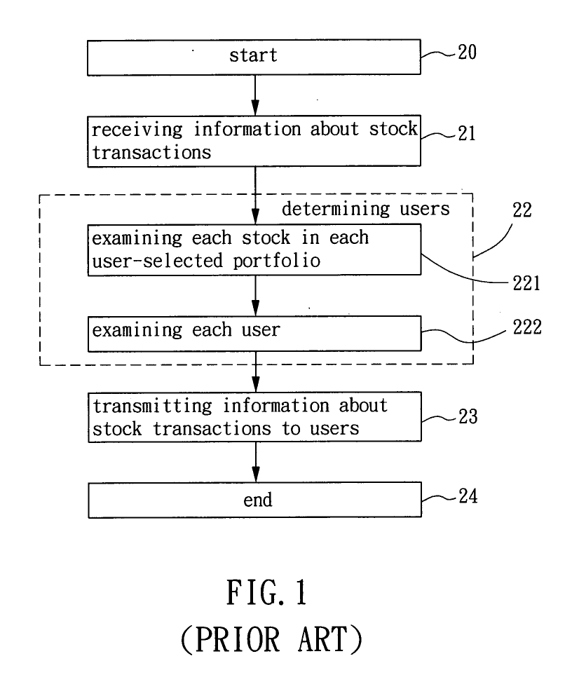

### DETAILED DESCRIPTION

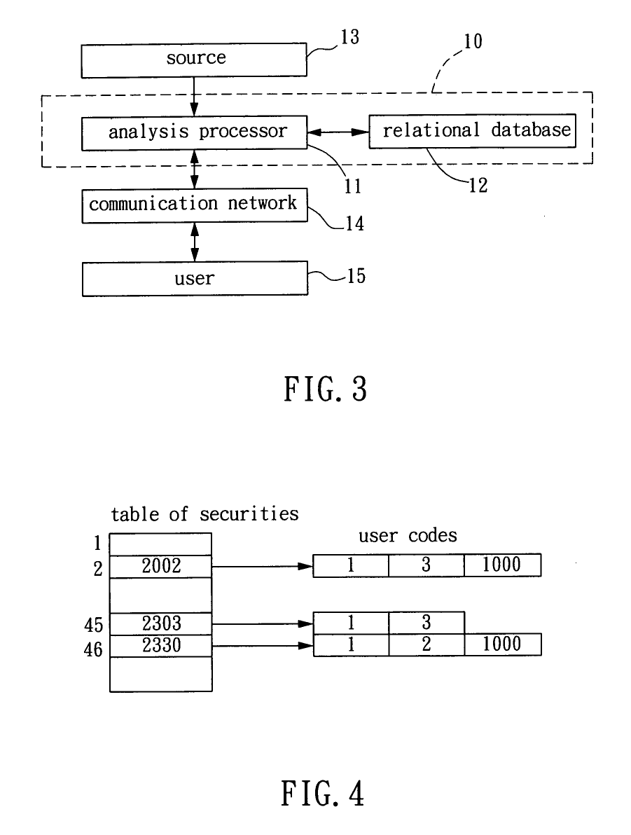

Referring to FIG. 3, which is a schematic view that shows a system for transmitting information about securities according to a preferred embodiment of the invention. Fundamentally, a system 10 for transmitting information about securities of the invention is constructed in an environment for electronic transactions based on a communication network 14 (which includes but not limited to: wireless communication systems like GSM, CDMA, GPRS, PHS, and WLAN; as well as wire-based communication systems like ADSL), and the system 10 allows an external user 15 (a handheld wireless communication device, for instance) to establish connections thereto. Moreover, the system 10 also receives information about securities from a source 13 (which is a service provider of financial securities, such as Taiwan Stock Exchange Corporation, GreTai Securities Market, and Taiwan Futures Exchange). The information about securities may include basic information or transaction details of each security, such as names of securities, codes of securities, and messages of securities. In a preferred embodiment of the invention, the user 15 may be a smart phone, a handheld stock manager, or a PDA with mobile communication; as long as the device used allows for wireless downloading of data. The user 15 connects to the system 10 of the invention via mobile communication networks like the General Packet Radio Service (GPRS), thereby allowing connections to be established between the system 10 and the user 15 via wireless mobile communication, and thus allowing information to be transmitted between the system 10 and the user 15.

In a preferred embodiment of the invention, the system 10 comprises: an analysis processor 11 and a relational database 12. The analysis processor 11 may receive all of the information about securities from the external source 13. The information about securities may include names of securities or futures (for example, “Taiwan Semiconductor Manufacturing Company Limited”), codes of all securities or futures (such as “2330”, and messages that correspond to the names and codes or each of the securities, like “transactions has exceeded the limit”). The analysis processor 11 not only receives the information about securities, but also extracts details from the information about securities; such as the codes of securities, for use as a reference for determining which users match information about stock transactions. The analysis processor 11 also receives all user information from external sources via a communication network 14. The user information may be user-selected stock portfolios, records of inquiries, records of transactions, and personal information. In this embodiment, the user information refers to the user-selected stock portfolios. After the analysis processor 11 has finished receiving all of the user-selected stock portfolios for all users of the system, the analysis processor 11 starts to statistically summarize relations between all users of the system and the securities, wherein codes of securities, names of securities, codes of users, or names of users may be used as references linking users to securities. In this particular embodiment of the invention, the codes of securities are used as a reference, and relations between individual securities and a plurality of users are found from the user-selected portfolios of all users; the relations are called security user relations in this case. For example, if there are currently four users called A, B, C, and D in the system; each of which is represented as 1, 2, 3, and 1000 in user codes, and the numbers 2002, 2303, and 2330 are codes that represent three different types of securities from the user-selected portfolios of the four users. Moreover, the user-selected portfolios of the four users are listed below:

A: 2330, 2303, and 2002

B: 2330

C: 2303 and 2002

D: 2002 and 2330

After statistically summarizing the aforesaid information with the analysis processor 11, three relations concerning users of securities are obtained and listed as follows:

2002: A, C, D

2303: A, C

2330: A, B, D

Wherein each relation concerning users of securities represent a specific stock and a plurality of users holding the stock (which means the user-selected portfolios of the plurality of users include the codes of the particular stocks). Subsequently, the analysis processor 11 writes the three relations concerning users of securities into a relational table, and the relational table is stored in a relational database 12. When the analysis processor 11 receives an entry of information related to the stock code 2303, it reads the relational table from the relational database 12, and determines that the users A and C have selected this particular stock code in their user-selected portfolios according to the relational table, because the relational table contains the relation between the stock code 2303 and its related users. Therefore, the analysis processor 11 may transmit the information related to the stock code 2303 to the users A and C.

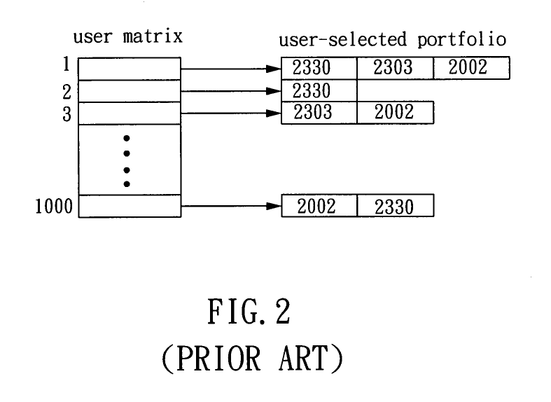

In reality, numbers of users and numbers of stocks in user-selected portfolios of the system are far greater than that in the aforesaid example. Referring back to FIG. 2, which is a schematic view that shows processing of loops in a conventional service for transmitting information about securities. Assuming that a server in such a service for transmitting information about securities may serve up to 1000 users, and each user may select 100 stocks in his/her own user-selected portfolio; if the conventional service shown in FIG. 2 is used to process search loops, an average number of loops required for transmitting information about securities of any one of the stocks to its users would be 1000×50.5=50500 (assuming that each user selects an average number of 100 stocks in his/her own user-selected portfolio, an average number of loops for a stock is: (1+2+3 . . . +100)/100=50.5). On the other hand, referring to FIG. 4, which is a schematic view that shows processing of loops in the system for transmitting information about securities according to the invention. Assuming that a server in the system of the invention may serve up to 1000 users; under the most extreme circumstances, each stock may have 1000 users listed in its user-selected portfolio, then a number of loops necessary for transmitting the information of any one of the stocks to its users would be 1000. In addition, assuming that a server in the system of the invention may serve up to 3000 users, an average number of loops required for transmitting the information of any one of the stocks to its users by using the conventional service for transmission would be 151500, whereas the number of loops required for the invention is 3000. In other words, the more users the servers in the system of the invention serve, the less the number of loops required for transmitting the information of any one of the stocks to its users.

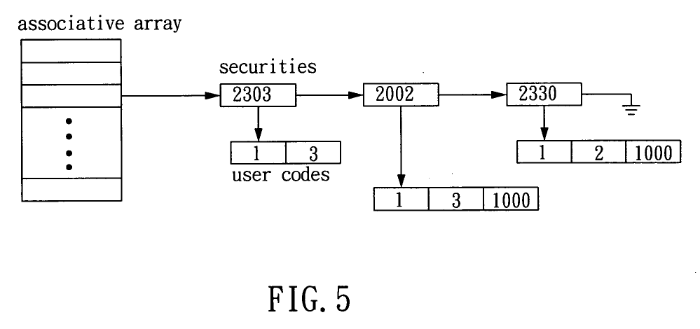

FIG. 5 is a schematic view that shows relational tables in the system for transmitting information about securities of the invention are arranged in associative arrays. When there are an excessive number of stocks in the system, the method of associative array (or Hash) may be employed to rearrange the stocks, so as to allow the analysis processor 11 to rapidly locate stock codes that match a particular entry of information about securities.

Generally, most users do not frequently change their portfolios once they have completed the selection of stocks. Therefore, after a relational table has been established, the analysis processor 11 does nothing more than updating the relational table from the relational database 12 when new users have selected new user-selected portfolios, or updating parts of relations concerning users of securities in the relational table from the relational database 12 (thus updating relations that correspond to requests) when current users have made changes in their user-selected portfolios. Therefore, each entry of relations concerning users of securities in the relational table may be easily kept up-to-date without taking up too much system resources. The system of the invention may transmit information about securities to correct users according to the relational table.

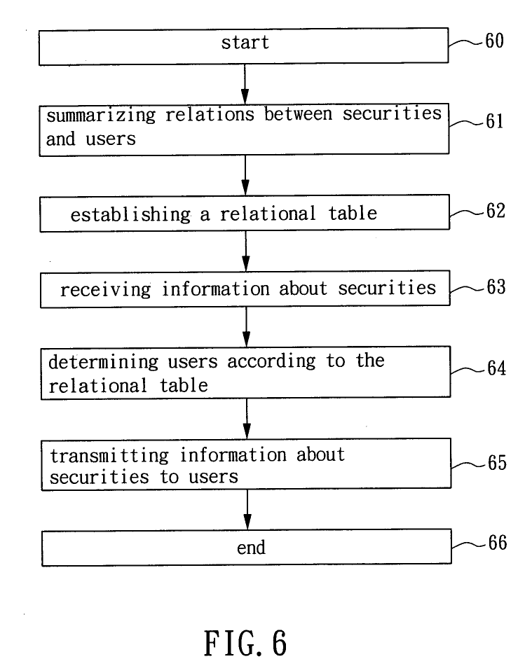

FIG. 6 is a flow chart that shows a method for transmitting information about securities according to a preferred embodiment of the invention; comprising:

Step 60: starting a service of the invention for transmitting information about securities.

Step 61: receiving records of user-selected portfolios of all users, and summarizing a plurality of records of user-selected portfolios to obtain a plurality of relations concerning users of securities; wherein each entry of relations concerning users of securities respectively represents a particular stock and a plurality of users matching this particular stock (which means a code for this particular stock shows up in the plurality of user-selected portfolios of users).

Step 62: writing the plurality of relations concerning users of securities into a relational table, wherein the plurality of relations concerning users of securities may be rearranged via the method of associative array so as to establish the relational table.

Step 63: receiving an entry of information about securities from an external source, and extracting a stock code from the information about securities to serve as a reference for determining users that matches the information about securities.

Step 64: reading a corresponding relation concerning users of securities from the relational table according to the extracted stock code obtained in the step 63, and determining which users match the information about securities according to the relation concerning users of securities.

Step 65: transmitting the information about securities to all corresponding users.

Step 66: ending the service for transmitting information about securities.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. A system for transmitting information about securities, comprising:
a relational database for storing a relational table that contains a plurality of relations concerning users of securities; and
an analysis processor for determining a plurality of users who match information about securities according to the relational table when said information about securities is received by the system, and then transmitting the information about securities to the determined plurality of users.

2. The system for transmitting information about securities of claim 1, wherein the relational table comprises at least one of following relations: a relation between names of securities and a plurality of users, and a relation between codes of securities and a plurality of users.

3. The system for transmitting information about securities of claim 1, wherein the information about securities comprises at least one of following details: names of securities, codes of securities, and messages of securities.

4. The system for transmitting information about securities of claim 1, wherein the plurality of relations concerning users of securities is obtained by allowing the analysis processor to statistically summarize a plurality of user information from all users uploaded into the system.

5. The system for transmitting information about securities of claim 4, wherein the user information comprises at least one of following details: user-selected securities, records of inquiries, records of completed transactions, and personal information.

6. The system for transmitting information about securities of claim 1, wherein relations between a plurality of securities and a plurality of users in the relational table are an associative array.

7. A method for transmitting information about securities, comprising:
(1) statistically summarizing a plurality of user information for obtaining a plurality of relations concerning users of securities;
(2) storing the plurality of relations concerning users of securities into a relational table; and
(3) when receiving information about securities, determining a plurality of users who match the information about securities according to the relational table, and then transmitting the information about securities to the determined plurality of users.

8. The method for transmitting information about securities of claim 7, wherein the user information comprises at least one of following details: user-selected securities, records of inquiries, records of completed transactions, and personal information.

9. The method for transmitting information about securities of claim 7, wherein the relational table comprises at least one of following relations: a relation between names of securities and a plurality of users, and a relation between codes of securities and a plurality of users.

10. The method for transmitting information about securities of claim 9, wherein relations between a plurality of securities and a plurality of users in the relational table are an associative array.

11. The method for transmitting information about securities of claim 7, wherein the information about securities comprises at least one of following details: names of securities, codes of securities, and messages of securities.

12. A system for transmitting information about securities, comprising:
an analysis processor for receiving at least an entry of information about securities from an external source, and receiving a plurality of user information from a plurality of external users; as well as statistically summarizing the received plurality of user information into a relational table; and
a relational database for storing at least the relational table;
wherein when the analysis processor receives the information about securities from the external source, the analysis processor determines a plurality of users who match the information about securities according to the relational table, and then transmits the information about securities to the plurality of users.

13. The system for transmitting information about securities of claim 12, wherein the relational table comprises at least one of following relations: a relation between names of securities and a plurality of users, and a relation between codes of securities and a plurality of users.

14. The system for transmitting information about securities of claim 12, wherein the information about securities comprises at least one of following details: names of securities, codes of securities, and messages of securities.

15. The system for transmitting information about securities of claim 12, wherein the user information comprises at least one of following details: user-selected securities, records of inquiries, records of completed transactions, and personal information.

16. The system for transmitting information about securities of claim 12, wherein relations between a plurality of securities and a plurality of users in the relational table are an associative array.
